(19) United States
(12) Patent Application Publication
(10) Pub. No.: US 2022/0164146 A1
(43) Pub. Date: May 26, 2022

(54) STORAGE SYSTEM AND CONTROL METHOD FOR STORAGE SYSTEM

(71) Applicant: Hitachi, Ltd., Tokyo (JP)

(72) Inventors: Masahiro TSURUYA, Tokyo (JP); Norio SHIMOZONO, Tokyo (JP); Akira YAMAMOTO, Tokyo (JP); Kentaro SHIMADA, Tokyo (JP); Takashi NAGAO, Tokyo (JP)

(21) Appl. No.: 17/472,845

(22) Filed: Sep. 13, 2021

(30) Foreign Application Priority Data
Nov. 25, 2020 (JP) 2020-194972
Mar. 23, 2021 (JP) 2021-048438

(51) Int. Cl. G06F 3/06

(52) U.S. Cl. CPC G06F 3/0661; G06F 3/0608; G06F 3/0673; G06F 3/0659; G06F 3/0665

(57) ABSTRACT

A storage system includes: a controller which includes a processor and a memory; and one or more storage devices. The controller sets a plurality of logical volumes, stores data related to a write request in the memory when the write request is received in the logical volume, and collectively compresses a plurality of pieces of data related to the write request in the memory and writes the compressed data to the storage device. When a plurality of pieces of data related to a plurality of the logical volumes that need to be written to the storage device exist in the memory, the controller selects the plurality of pieces of data in an identical logical volume, and collectively compresses the plurality of pieces of selected data and writes the compressed data in the storage device.

### CLAIM OF PRIORITY

The present application claims priority from Japanese patent applications JP 2020-194972 filed on Nov. 25, 2020 and JP 2021-048438 filed on Mar. 23, 2021, the contents of which are hereby incorporated by reference into this application.

### BACKGROUND OF THE INVENTION

### 1. Field of the Invention

The present invention relates to a data compression control technique suitable for a storage system having a write-once data structure and a data compression function.

### 2. Description of the Related Art

In recent years, the importance of technologies that generate new values by accumulating and analyzing enormous data, represented by Internet of Things (IoT) and Artificial Intelligence (AI), has increased. These technologies require a storage system having not only a capacity capable of accumulating the enormous data but also high input/output (I/O) performance for analyzing the accumulated data.

Instead of a hard disk drive (HDD), which has been mainly used as a storage medium of a storage system having high I/O performance in conventional techniques, there is an all flash array (AFA) equipped with a solid state device (SSD) having overwhelmingly higher I/O performance than the HDD.

In general, the AFA is more expensive than the storage system equipped with the conventional HDD. This is because the price (bit cost) per unit capacity of the SSD is more expensive than that of the HDD. On the other hand, the bit cost of a nonvolatile semiconductor memory, which is a main component of the SSD, has been reduced due to the advancement in miniaturization technology, and thus, the price of the SSD has also been reduced. As a result, the price of the AFA has been reduced to support the spread of the AFA.

However, an increase rate of data handled by a user is higher than the speed of reduction of the bit cost of the SSD. Thus, in the AFA, the bit cost is reduced by mounting a data reduction function such as compression, and the improvement of a data reduction rate leads to further reduction of the bit cost.

As a scheme for improving a compression rate, there is a scheme of performing rearrangement based on the similarity of data to perform compression as disclosed in U.S. Pat. No. 9,367,557 A. In the related art described in U.S. Pat. No. 9,367,557 A, a scheme for improving a compression rate by collectively compressing pieces of highly similar data in a file is described.

### SUMMARY OF THE INVENTION

As described above, the compression rate can be improved by collectively compressing pieces of highly similar data. Considering a case of applying the technique in U.S. Pat. No. 9,367,557 A for the file to a block storage, pieces of data with neighboring logical block addresses (LBAs) tend to have high similarity in the block storage. Thus, the compression rate can be improved by expanding a unit (compression unit) of collective compression and collecting data in a unit of LBA-consecutive data.

However, when the compression unit is expanded in the unit of data in which LBAs are consecutive, read-modify-write (RMW) occurs in a case where the compression unit is larger than a write data unit from a host (host write unit) and LBAs are inconsecutively (randomly) accessed.

In the above-described scheme of expanding the compression unit in the unit of an LBA consecutive area (which is hereinafter referred to as a conventional scheme), two main problems occur due to the occurrence of RMW. The first problem is deterioration in I/O performance of the storage system.

In write processing with RMW, a series of processes of reading compressed data from the SSD, decompressing the read compressed data, modifying the read compressed data with host write data, and compressing the modified data is increased as compared with write processing without RMW.

Thus, a processor responsible for the series of processes and hardware (H/W) responsible for data transfer become bottlenecks, so that the I/O performance of the AFA deteriorates.

The second problem is a decrease in rewriting life of the SSD accompanying an increase in the amount of write to the SSD mounted in the storage system. As described above, the read and modified data is also written to the SSD in addition to the host write data by the RMW. In addition, a nonvolatile semiconductor device mounted on the SSD has an upper limit on the number of times of rewriting, and it is difficult to read or write data if this upper limit is exceeded. Thus, as the amount of write to the SSD with respect to the amount of host write increases, the rewriting life of the SSD decreases.

Meanwhile, the above two problems can be solved by collectively compressing the write data from the host in order while ignoring the continuity of the LBA, but pieces of data having no similarity are collected, which makes it difficult to expect the effect of improving the compression rate.

Therefore, the invention has been made in view of the above problems, and an object thereof is to improve a data reduction rate and reduce the bit cost of an AFA.

A representative example of the invention is a storage system including: a controller which includes a processor and a memory; and one or more storage devices. The controller sets a plurality of logical volumes, stores data related to a write request in the memory when the write request is received in the logical volume, and collectively compresses a plurality of pieces of data related to the write request in the memory and writes the compressed data to the storage device. When a plurality of pieces of data related to a plurality of the logical volumes that need to be written to the storage device exist in the memory, the controller selects the plurality of pieces of data whose writing positions in an identical logical volume are inconsecutive, and collectively compresses the plurality of pieces of selected data and writes the compressed data in the storage device.

According to an aspect of the invention, the data reduction rate can be improved, and the bit cost of the AFA can be reduced. In addition, it is possible to prevent the occurrence of RMW accompanying an increase of a compression unit with respect to random write in a size less than the compression unit from a user, and to suppress deterioration in I/O performance of the AFA and deterioration in the life of an SSD.

Details of at least one embodiment of a subject matter disclosed in this specification are set forth in the accompanying drawings and the following description. Other features, aspects, and effects of the disclosed subject matter will be apparent from the following disclosure, drawings, and claims.

### BRIEF DESCRIPTION OF THE DRAWINGS

FIG. 1 is a block diagram illustrating an example of a configuration of an information system including a storage system according to a first embodiment;

FIG. 2 is a block diagram illustrating an example of a configuration of a main memory according to the first embodiment;

FIG. 3 is a block diagram illustrating an example of a configuration of a program area according to the first embodiment;

FIG. 4 is a block diagram illustrating an example of a configuration of a management information area according to the first embodiment;

FIG. 5 is a table illustrating an example of a configuration of a physical device (PDEV) management table according to the first embodiment;

FIG. 6 is a table illustrating an example of a configuration of a pool volume (PVOL) management table according to the first embodiment;

FIG. 7 is a table illustrating an example of a configuration of an LDEV management table according to the first embodiment;

FIG. 8 is a table illustrating an example of a configuration of a PVOL page management table according to the first embodiment;

FIG. 9 is a table illustrating an example of a configuration of an LDEV page management table according to the first embodiment;

FIG. 10 is a table illustrating an example of a configuration of a buffer segment management table according to the first embodiment;

FIG. 11 is a table illustrating an example of a configuration of a cache segment management table according to the first embodiment;

FIG. 12 is a table illustrating an example of a configuration of a collective compression group management table according to the first embodiment;

FIG. 13 is a view illustrating a relation among an LDEV, a PVOL, and a PDEV in a storage system according to the first embodiment;

FIG. 14 is a view illustrating an example of a write data flow in a collective data compression scheme of a comparative example in a storage system according to the comparative example;

FIG. 15 is a view illustrating an example of a write data flow in a collective data compression scheme based on the invention in the storage system according to the first embodiment;

FIG. 16 is a flowchart illustrating an example of processing based on an I/O request from a host in the storage system according to the first embodiment;

FIG. 17 is a flowchart illustrating an example of a process of securing a cache in the course of processing a write request in the storage system according to the first embodiment;

FIG. 18 is a flowchart illustrating an example of a process of performing collective data compression in the course of processing the write request in the storage system according to the first embodiment;

FIG. 19 is a flowchart illustrating an example of PVOL garbage collection processing in the storage system according to the first embodiment;

FIG. 20 is a flowchart illustrating an example of a process of generating a PVOL free page in the course of the PVOL garbage collection processing in the storage system according to the first embodiment;

FIG. 21 is a view illustrating an example of a write data flow in a collective data compression scheme that enables garbage collection with high processor processing efficiency in a storage system according to a second embodiment;

FIG. 22 is a flowchart illustrating an example of a process of performing collective data compression in the course of processing a write request in the storage system according to the second embodiment;

FIG. 23 is a flowchart illustrating an example of a process of generating a PVOL free page in the course of PVOL garbage collection processing in the storage system according to the second embodiment; and

FIG. 24 is a flowchart illustrating an example of a process of collectively compressing valid LDEV pages again in the course of a process of generating a PVOL free page in the storage system according to the second embodiment.

### DESCRIPTION OF THE PREFERRED EMBODIMENTS

Hereinafter, embodiments will be described with reference to the drawings. Incidentally, the embodiments are merely examples for realizing the invention and do not limit a technical scope of the invention.

Various kinds of information will be sometimes described with an expression, “xxx table” in the following description, but the various kinds of information may be expressed with a data structure other than the table. In order to indicate that the information is not dependent on the data structure “xxx table” can be called “xxx information”.

In addition, a number is used as identification information of an element in the following description, but another type of identification information (for example, a name or an identifier) may be used.

In addition, in the following description, a common sign (or a reference sign) among reference signs is used in the case of describing the same type of elements without discrimination, and reference signs (or IDs of the elements) are used in the case of discriminating the same type of elements.

In the following description, a “main memory” may be one or more storage devices including a memory. For example, the main memory may be at least a main storage device between the main storage device (typically a volatile storage device) and an auxiliary storage device (typically a nonvolatile storage device). In addition, a storage section may include at least one of a cache area (for example, a cache memory or a partial area thereof) and a buffer area (for example, a buffer memory or a partial area thereof).

In the following description, “PDEV” means a physical storage device, and may typically be a nonvolatile storage device (for example, an auxiliary storage device). The PDEV may be, for example, a hard disk drive (HDD) or a solid-state drive (SSD).

In the following description, “RAID” is an abbreviation for redundant array of independent (or inexpensive) disks. A RAID group includes a plurality of PDEVs and stores data according to a RAID level associated with the RAID group.

In addition, in the following description, a “PVOL” includes a plurality of PDEVs, and these PDEVs may form a RAID group.

In addition, in the following description, an “LDEV” means a logical storage device and is configured using some storage areas or all storage areas of the “PVOL”, and a host executes an I/O request to the “LDEV”. The LDEV is a logical volume. The PVOL is a second volume, and the allocation of a storage area is managed via the PVOL between the LDEV and the PDEV.

In addition, a “write-once data structure” means a structure in which data after updating is stored in a different physical position from data before updating, and the data is updated by changing a reference destination of the stored data. Since a data size after compression varies depending on a content of data before compression, it is necessary to store compressed data in a PVOL (that is, the PDEV corresponding to the PVOL) without a gap in order to increase the efficiency of data reduction.

Incidentally, the physical position is a position in the PVOL, and is a position of data that is commonly recognized by a CTL and a PDEV BOX. In the PDEV using a flash memory in the PDEV BOX, update data is stored at another position in the flash memory and appears to be overwritten at the same position in the PVOL by mapping change due to the nature of the flash memory. The “write-once data structure” is different from this and is processing in the CTL. A write-once scheme may be performed separately in the CTL and the PDEV.

The “write-once data structure” can store compressed data sequentially from arbitrary positions of the PVOL, is suitable for a storage system having a data reduction function such as compression. In the following description, the storage system has the “write-once data structure”, and updated data is stored in a free area of a PVOL when an “LDEV” is updated by host write, and the data is updated by switching a reference destination of the data of the “LDEV”.

In addition, hereinafter, in a case where processing is described with a “program” as a subject, the subject of the processing may be a storage controller or a processor since the program is executed by the processor (for example, a central processing unit (CPU)) included in the storage controller to perform the prescribed processing appropriately using a storage resource (for example, the main memory) and a communication interface device (for example, HCA). In addition, the storage controller (CTL) may include a hardware circuit that performs a part or whole of the processing. The computer program may be installed from a program source. The program source may be, for example, a program distribution server or a computer-readable storage medium.

In the following description, the “host” is a system that transmits an I/O request to the storage system, and may include an interface device, a storage section (for example, a memory), and a processor connected to the interface device and the storage section. The host system may be configured using one or more host computers. At least one host computer may be a physical computer, and the host system may include a virtual host computer in addition to the physical host computer.

Hereinafter, an example of a block storage system that collectively compresses data in units of logical devices or in units of logical devices and neighboring LBAs will be described. Incidentally, the embodiments to be described hereinafter do not limit the invention according to the claims, and further, all combinations of features described in the embodiments are not necessarily indispensable for the solution of the invention.

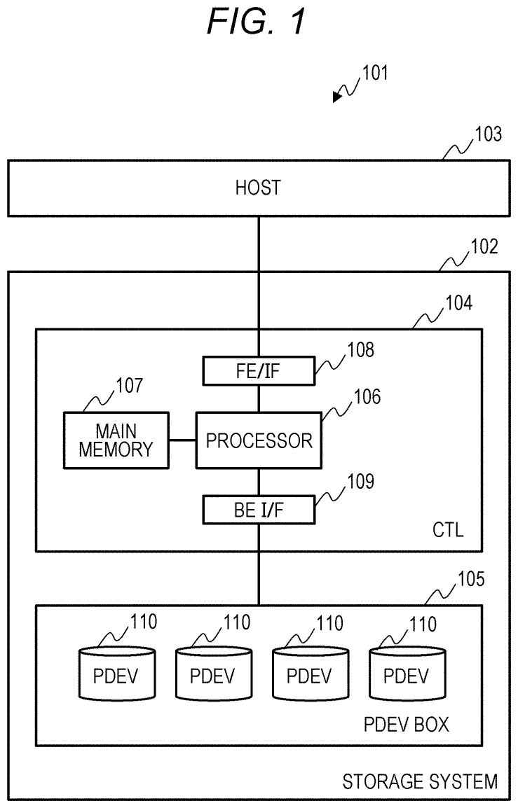

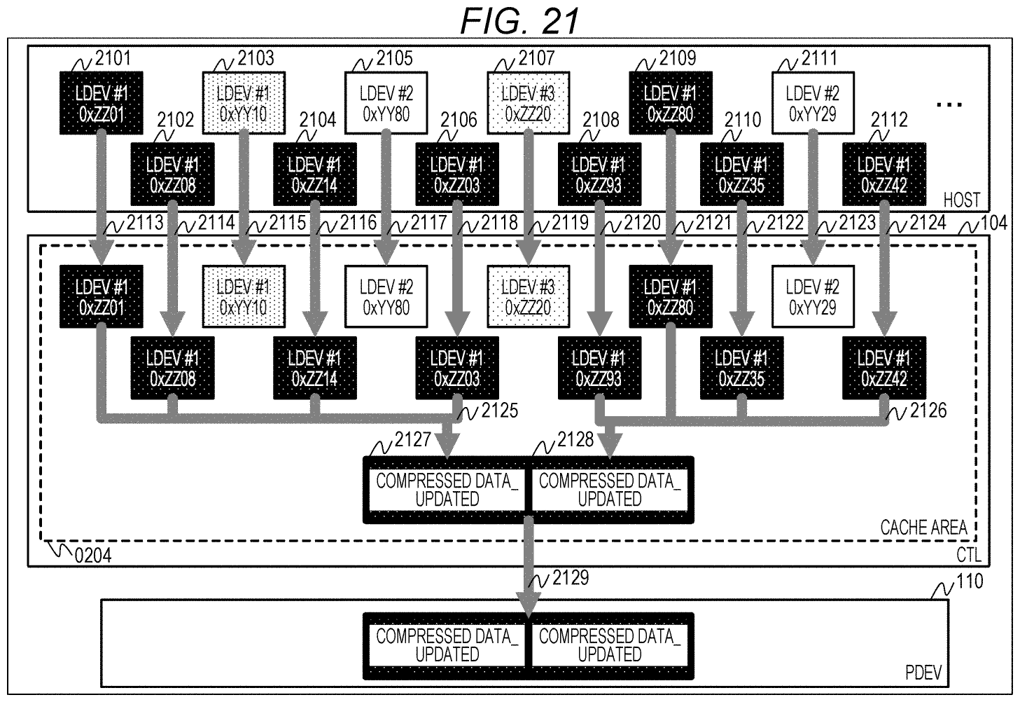

In the present specification, two embodiments will be described. A first embodiment will be described with reference to FIGS. 1 to 20, and a second embodiment will be described with reference to FIGS. 21 to 24. Incidentally, differences from the first embodiment will be mainly described in the second embodiment.

### First Embodiment

FIG. 1 is a diagram illustrating an example of a configuration of an information system 101.

The information system 101 includes one or more storage systems 102 and one or more hosts 103.

The storage system 102 includes one or more controllers (CTLs) 104 and one or more PDEV BOXs 105, and has a write-once data structure. The PDEV BOX 105 includes one or more PDEVs 110. In FIG. 1, the CTL 104 and the PDEV BOX 105 are directly connected, but may be connected via a network.

In addition, the PDEV 110 may be configured using an all flash array (AFA) equipped with a nonvolatile semiconductor memory. In addition, as the write-once data structure, for example, well-known or known techniques, such as a log-structured scheme, may be applied.

The CTL 104 includes a processor 106, a main memory 107, a front-end interface (FE I/F) 108, and a back-end interface (BE I/F) 109. The number of various elements forming the CTL 104 may be one or more.

The processor 106 controls the entire CTL 104, and operates based on a program stored in the main memory 107. The FE I/F 108 is controlled by the processor 106, and transmits and receives an I/O request and I/O data to and from the host 103. The BE I/F 109 is controlled by the processor 106 and transmits and receives I/O data and the like to and from the PDEV 110 via the PDEV BOX 105.

The storage system 102 has a configuration in which one CTL 104 is mounted in the present embodiment, but may have a configuration in which a plurality of CTLs are mounted and the CTLs have redundancy.

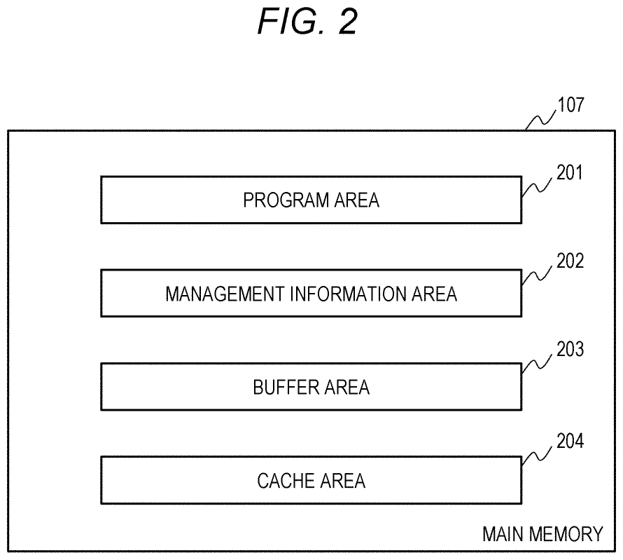

FIG. 2 is a diagram illustrating an example of a configuration of the main memory 107.

In the main memory 107, a program area 201, a management information area 202, a buffer area 203, and a cache area 204 are secured.

The program area 201 is an area in which each program for the processor 106 to perform processing is stored.

The management information area 202 is an area accessed from the processor 106 and is an area in which various management tables are stored.

The buffer area 203 and the cache area 204 are areas in which data is temporarily stored during data transfer by the FE I/F 108, the BE I/F 109, and the like. Incidentally, each of the buffer area 203 and the cache area 204 includes a plurality of segments (units obtained by dividing each area), and areas are secured in units of segments.

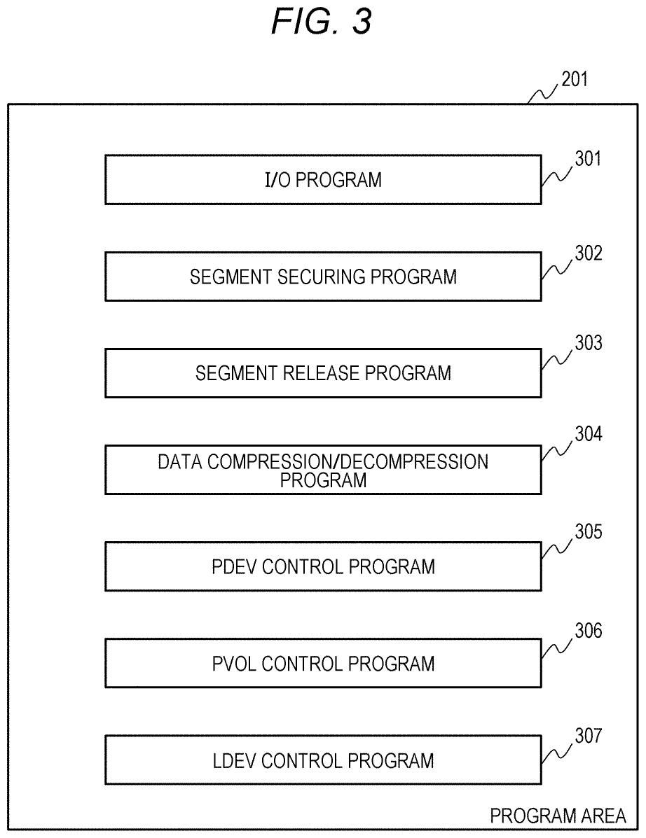

FIG. 3 is a diagram illustrating an example of the program stored in the program area 201.

The program area 201 stores, for example, an I/O program 301, a segment securing program 302, a segment release program 303, a data compression/decompression program 304, a PDEV control program 305, a PVOL control program 306, and an LDEV control program 307.

An I/O request from the host 103 causes execution of the I/O program 301 to execute corresponding processing in accordance with the I/O request.

The segment securing program 302 is called in the course of processing the I/O request by the I/O program 301, and secures a buffer segment and a cache segment in the buffer area 203 and the cache area 204. The segment release program 303 is called in the course of processing the I/O request by the I/O program 301, and releases the buffer segment and the cache segment from the buffer area 203 and the cache area 204.

The data compression/decompression program 304 is called in the course of processing the I/O request by the I/O program 301, and compresses data received from the host 103 or decompresses compressed data in order to respond to the host 103 with the data.

The PDEV control program 305 manages an area and a state of the PDEV 110 and controls transmission and reception of I/O data. The PVOL control program 306 controls an area, a state, and the like of a PVOL. The LDEV control program 307 controls an area, a state, and the like of an LDEV.

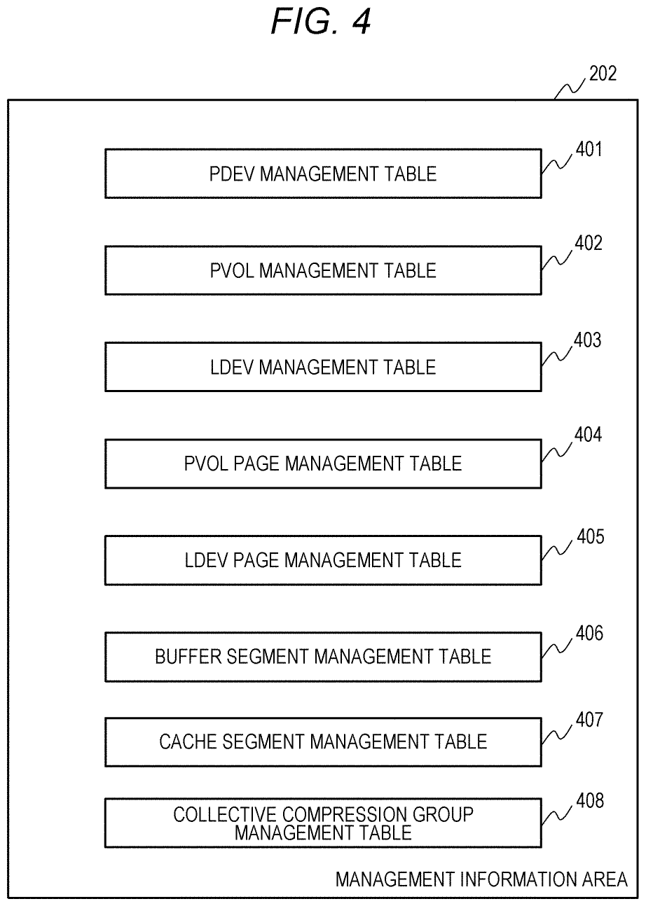

FIG. 4 is a diagram illustrating an example of information stored in the management information area 202.

The management information area 202 stores a PDEV management table 401, a PVOL management table 402, an LDEV management table 403, a PVOL page management table 404, an LDEV page management table 405, a buffer segment management table 406, and a cache segment management table 407.

The PDEV management table 401 indicates a state of the PDEV 110 and a correspondence relationship with a PVOL. The PVOL management table 402 indicates a state of a PVOL, a correspondence relationship with the PDEV 110, and a correspondence relationship with an LDEV.

The LDEV management table 403 indicates a state of an LDEV and a correspondence relationship between a PVOL and the LDEV. The PVOL page management table 404 is used to manage a page obtained by dividing an area of a PVOL by a unit capacity.

The LDEV page management table 405 is used to manage a page obtained by dividing an area of an LDEV by a unit capacity. The buffer segment management table 406 is used to manage the buffer area 203. The cache segment management table 407 is used to manage the cache area 204. The collective compression group management table 408 is used to manage data to be collectively compressed.

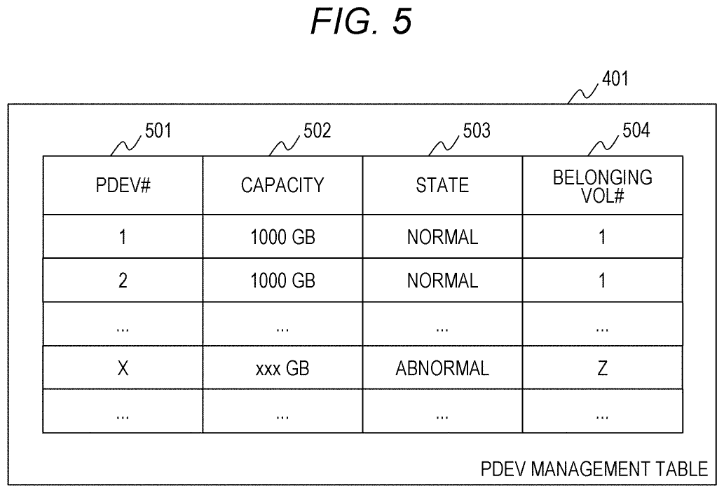

FIG. 5 is a table illustrating an example of a configuration of the PDEV management table 401.

The PDEV management table 401 includes entries of a PDEV #501, a capacity 502, a state 503, and a belonging PVOL #504.

The PDEV #501 is an identifier of the PDEV 110. The capacity 502 indicates a capacity capable of storing data of the PDEV 110. The state 503 indicates a state of whether the PDEV 110 is normally operating (whether a failure occurs). The belonging PVOL #504 indicates any PDEV to which the corresponding PDEV 110 belongs.

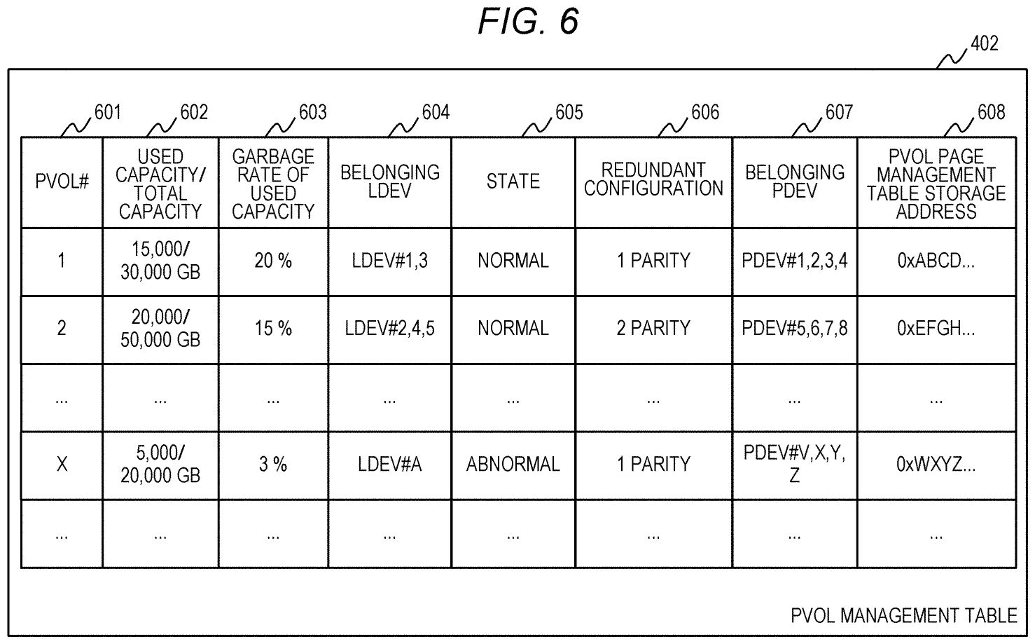

FIG. 6 is a table illustrating an example of a configuration of the PVOL management table 402.

The PVOL management table 402 includes entries of a PVOL #601, a used capacity/total capacity 602, a garbage rate of used capacity 603, a belonging LDEV 604, a state 605, a redundant configuration 606, a belonging PDEV 607, and a PVOL page management table storage address 608.

The PVOL #601 is an identifier of a PVOL. The used capacity/total capacity 602 indicates a used capacity in which data is already stored and a total capacity also including a capacity in which data is not stored, in a PVOL. The garbage rate of used capacity 603 indicates a garbage rate of an area where data is already stored in a PVOL (a ratio of invalid data to an area which has a log structure and in which log writing (postscript of data) is performed).

The belonging LDEV 604 indicates an identifier of an LDEV cut out from a PVOL. The state 605 indicates whether a state of a PVOL is normal. The redundant configuration 606 indicates a RAID level of the PDEV 110 forming a PVOL.

The belonging PDEV 607 indicates the PDEV 110 forming a PVOL. The PVOL page management table storage address 608 indicates an address on the main memory 107 that stores a table for managing a page obtained by dividing a PVOL by a unit capacity.

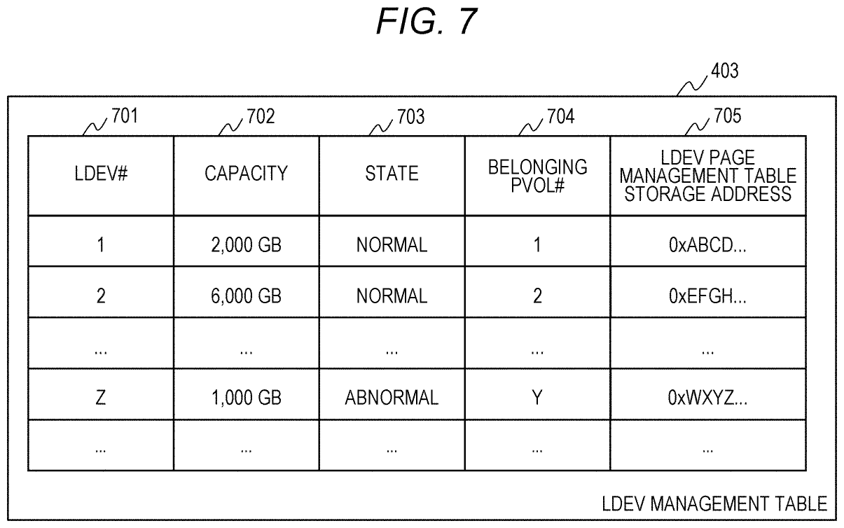

FIG. 7 is a table illustrating an example of a configuration of the LDEV management table 403.

The LDEV management table 403 includes an LDEV #701, a capacity 702, a state 703, a belonging PVOL #704, and an LDEV page management table storage address 705.

The LDEV #701 is an identifier of an LDEV. The capacity 702 indicates a capacity capable of storing data in an LDEV. The state 703 indicates whether I/O with respect to an LDEV can be normally performed. The belonging PVOL #704 indicates an identifier of a PVOL to which an LDEV belongs. The LDEV page management table storage address 705 indicates an address on the main memory 107 that stores a table for managing a page obtained by dividing an LDEV by a unit capacity.

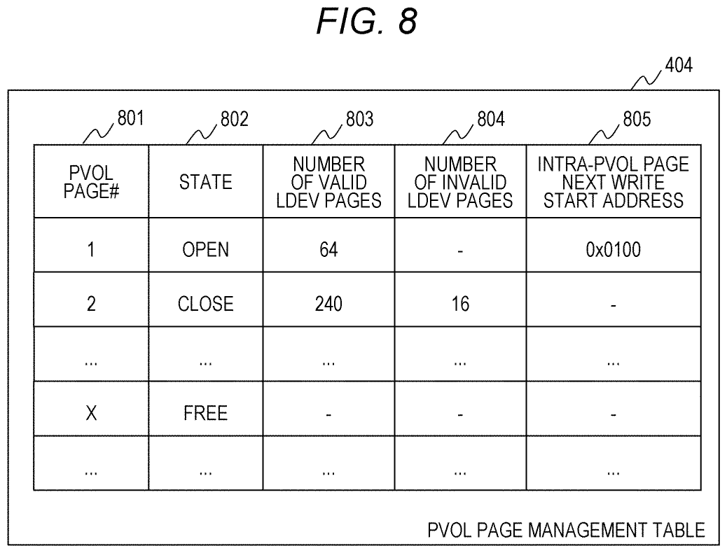

FIG. 8 is a table illustrating an example of a configuration of the PVOL page management table 404.

The PVOL page management table 404 includes a PVOL page #801, a state 802, the number of valid LDEV pages 803, the number of invalid LDEV pages 804, and an intra-PVOL page next write start address 805.

The PVOL page #801 is an identifier of a PVOL page. The state 802 is a state of a PVOL page, where “open” indicates that the PVOL page is being written (state in which data is stored halfway in the PVOL page), “close” indicates that write (writing) has been already performed, and “free” indicates that the PVOL page has not been used.

The number of valid LDEV pages 803 indicates the number of LDEV pages storing valid data among PVOL pages. The number of invalid LDEV pages 804 indicates the number of LDEV pages in which invalid data is stored among PVOL pages. The intra-PVOL page next write start address 805 indicates a head address of an area where write has not been completed from a head of a PVOL page in the PVOL page in which the state 802 is “open”.

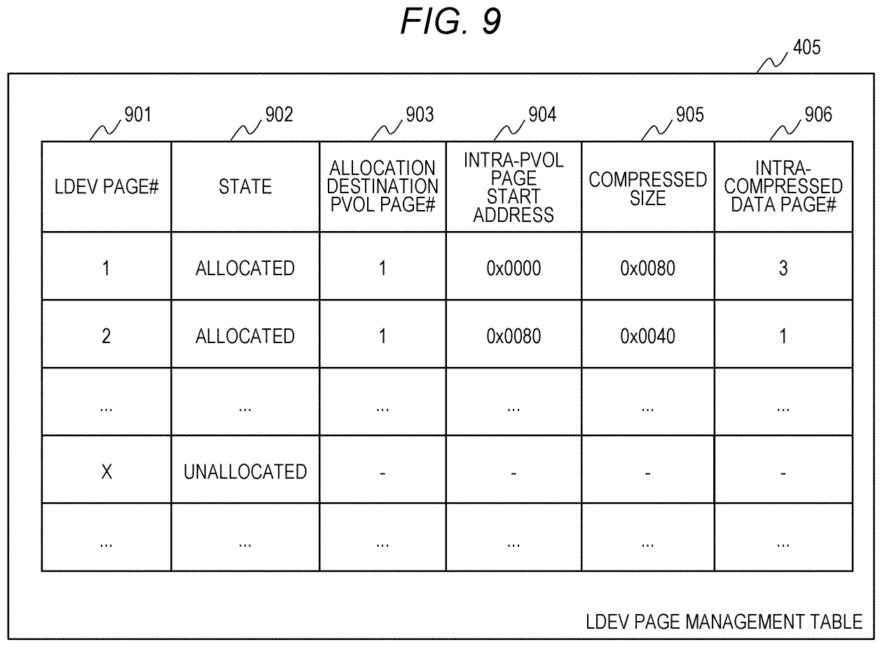

FIG. 9 is a table illustrating an example of a configuration of the LDEV page management table 405.

The LDEV page management table 405 includes an LDEV page #901, a state 902, an allocation destination PVOL page #903, an intra-PVOL page start address 904, a compressed size 905, and an intra-compressed data page #906.

The LDEV page #901 is an identifier of an LDEV page. The LDEV state 902 indicates whether an LDEV page is allocated to a PVOL page. The allocation destination PVOL page #903 indicates a PVOL page # to which an LDEV page is allocated. Hereinafter, “#” indicates an identifier or a number.

The intra-PVOL page start address 904 indicates a start address in a PVOL page in which compressed data including an LDEV page is stored. The compressed size 905 indicates a size of compressed data including an LDEV page.

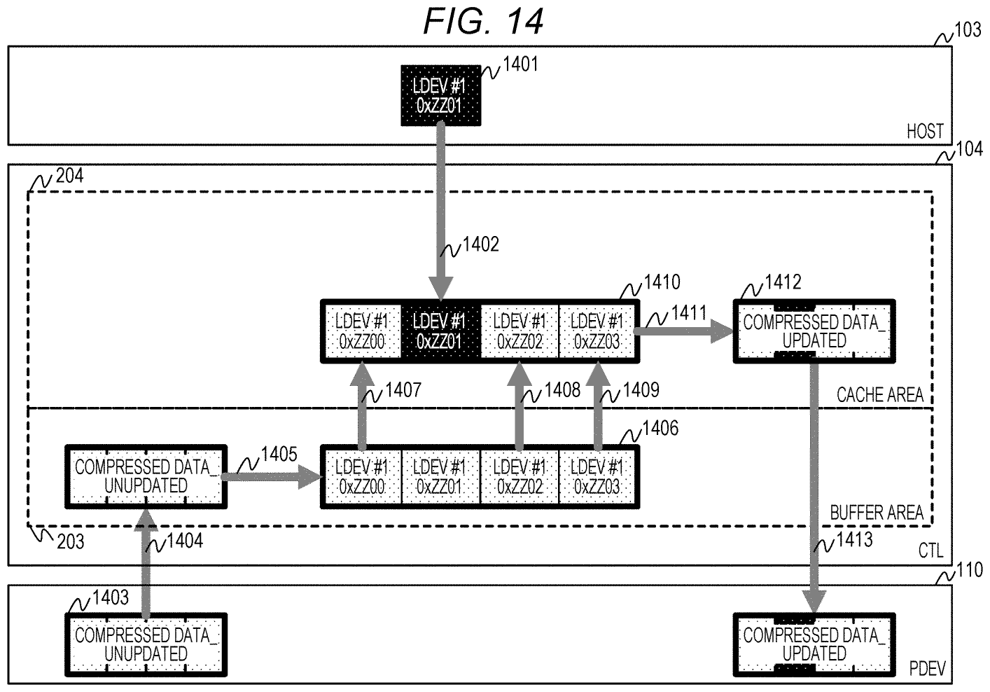

The intra-compressed data page #906 is an identifier for identifying an LDEV page out of compressed data including the LDEV page. Since the CTL 104 of the present embodiment collectively compresses a plurality of (for example, four) pieces of data having close LBAs in the same LDEV # as will be described later in FIG. 14, the intra-compressed data page #906 is a value indicating a position of an LDEV page before compression stored in the compressed data.

When a plurality of LDEVs are set in the storage system 102, the LDEV page management table 405 is set for each LDEV.

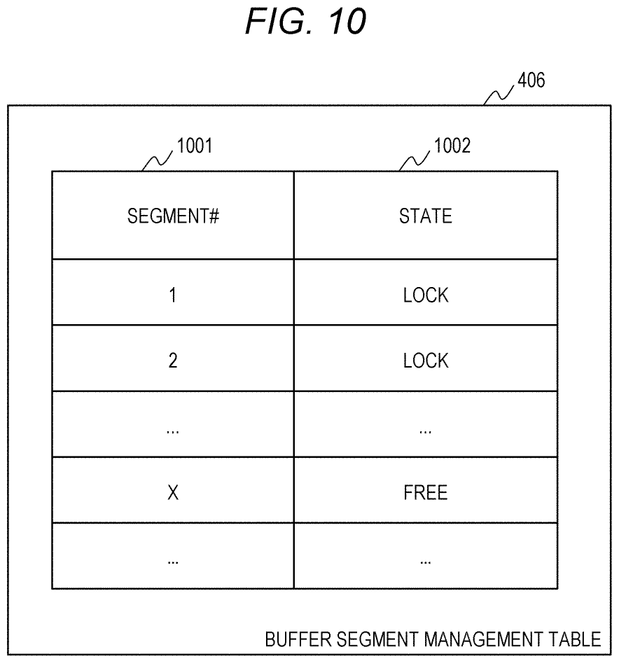

FIG. 10 is a table illustrating an example of a configuration of the buffer segment management table 406. The buffer segment management table 406 includes a segment #1001 and a state 1002. The segment #1001 is an identifier of a buffer segment. The state 1002 indicates whether a buffer segment is secured (lock or free).

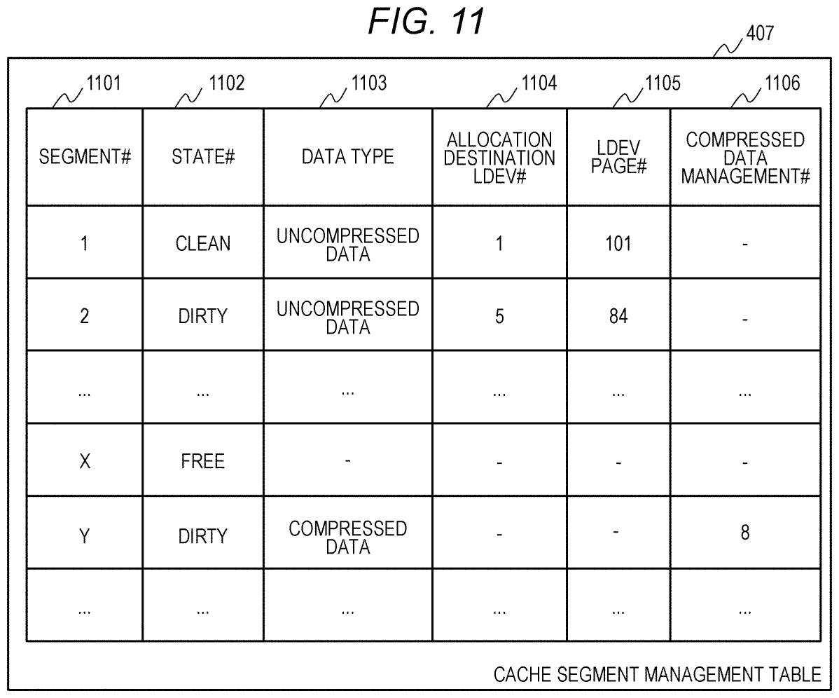

FIG. 11 is a table illustrating an example of a configuration of the cache segment management table 407.

The cache segment management table 407 includes a segment #1101, a state 1102, a data type 1103, an allocation destination LDEV #1104, an LDEV page #1105, and a compressed data management #1106.

The segment #1101 is an identifier of a cache segment. The state 1102 is a state of a cache segment, where “clean” indicates that the latest data has been stored in the PDEV 110, “dirty” indicates that data on the cache segment is the latest, and “free” indicates that the cache segment has not been used. The data type 1103 indicates whether data stored in a cache segment is “uncompressed data” which is data that has not been compressed, or “compressed data” which is data that has been already compressed.

The allocation destination LDEV #1104 indicates an LDEV # to which data stored in a cache segment belongs. The LDEV page #1105 indicates an LDEV page # in the LDEV # to which the data stored in the cache segment belongs. The compressed data management #1106 is an identifier of compressed data stored in a cache.

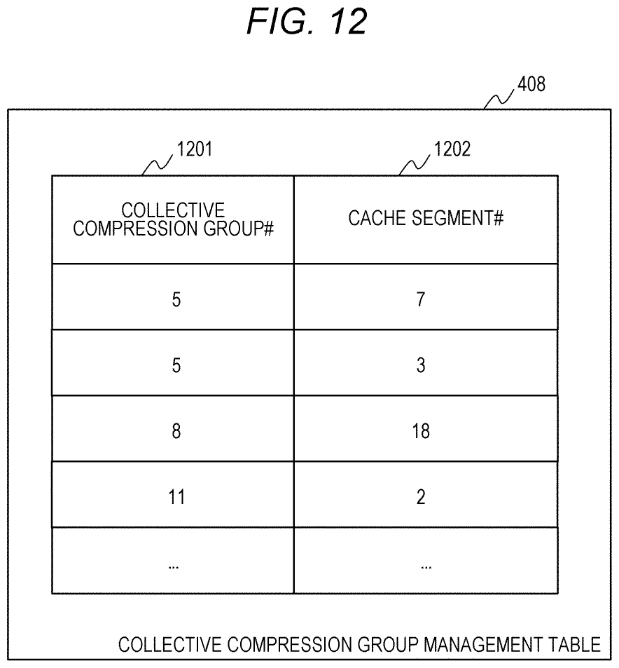

FIG. 12 is a table illustrating an example of a configuration of the collective compression group management table 408. The collective compression group #1201 is an identifier for grouping pieces of data that can be collectively compressed. The cache segment #1202 corresponds to the segment #1101 of the cache segment management table 407 and indicates a cache segment belonging to the collective compression group #1201.

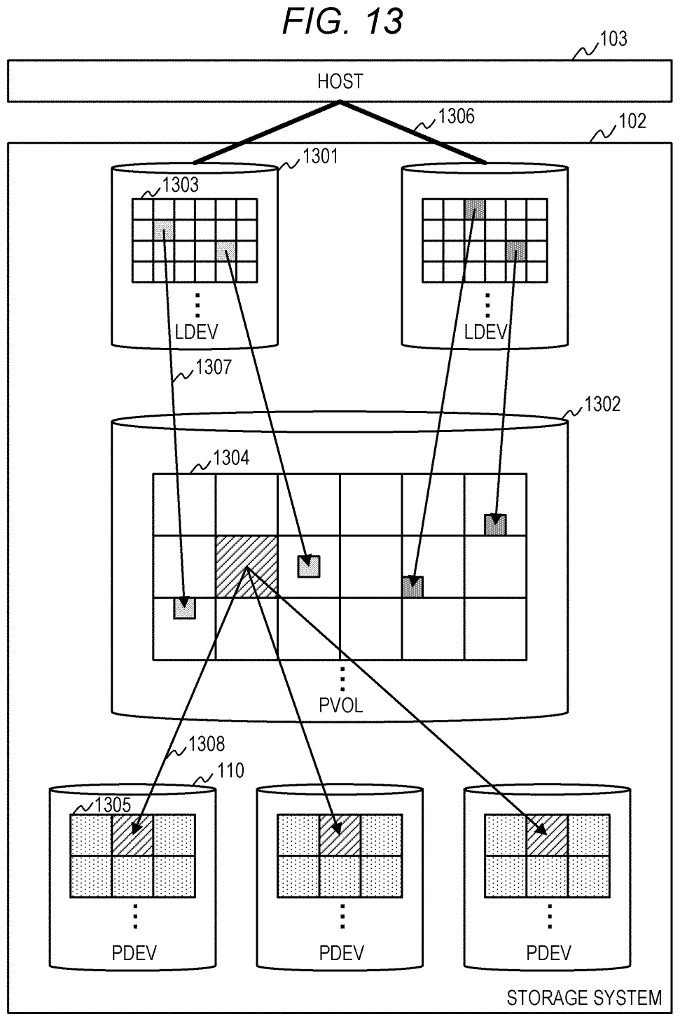

FIG. 13 is a view illustrating a correspondence relationship among the host 103, an LDEV, a PVOL, the PDEV 110, an LDEV page, and a PVOL page.

One or more LDEVs 1301 exist in the storage system 102 and are directly accessed from the host 103. A PVOL 1302 is a pool including one or more PDEVs 110.

The LDEV 1301 includes one or more LDEV pages 1303. The PVOL 1302 includes one or more PVOL pages 1304. The PDEV 110 is divided into one or more areas 1305 and corresponds to the PVOL page 1304.

The host 103 is connected to the one or more LDEVs 1301 (1306). The LDEV page 1303 is allocated to the PVOL page 1304 (1307). The PVOL page 1304 is allocated to the divided area 1305 of the PDEV 110 (1308).

FIG. 14 is a view illustrating an example of a data collective compression processing sequence using a comparative example in the storage system 104. In FIG. 14, components of the information system 101 are partially omitted in order to describe the data collective compression processing sequence. In addition, a size of write data from the host 103 is equivalent to that of the LDEV page 1303, and a collective compression unit is described as four LDEV pages 1303.

The host 103 writes data 1401 to the CTL 104 (1402). The write data (1401) is stored in the cache area 204.

In order to read data of a neighboring LBA to be collectively compressed with the data 1401, the CTL 104 reads compressed data_unupdated 1403 including the data 1401 from the PDEV 110 (1404).

The compressed data_unupdated 1403 is stored in the buffer area 203 and then decompressed (1305). Decompressed data 1406 is temporarily stored in the buffer area 203, and then, data other than the data 1401 is transferred to the cache area 204 (read and modified), and is combined with the data 1401 already stored in the cache area 204, thereby completing the reading and modification (1407, 1408, 1409).

Data 1410 after the reading and modification is collectively compressed (1411). Compressed data_updated 1412 is temporarily stored in the cache area 204 and then transferred to the PDEV 110 (1413).

Finally, the LDEV page management table 405 is updated, and a reference destination of an LDEV page included in the compressed data_unupdated 1403 is switched to the compressed data_updated 1412. As a result, the compressed data_unupdated 1403 is all invalid data.

In this manner, the data 1410 is collectively compressed in LBA-consecutive areas in the comparative example, and thus, the read-modify-write occurs when a size of the write data (1401) is smaller than a compression unit, and inconsecutive (random) LBAs are accessed.

When host write is accessed in the order of LBAs (sequentially), the read-modify-write does not occur regardless of a host write unit.

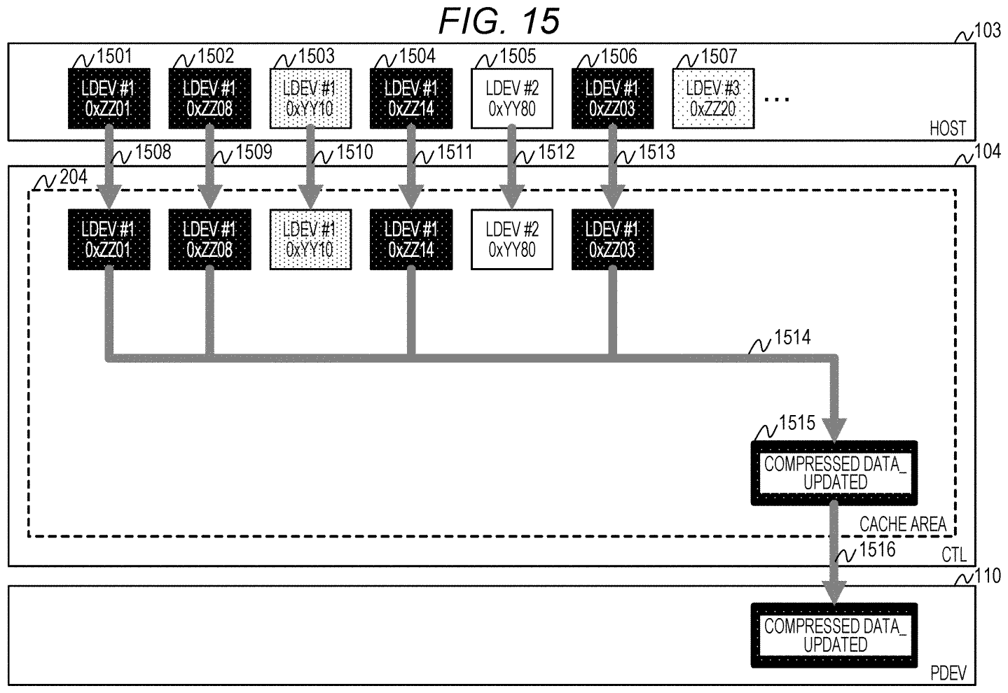

FIG. 15 is a view illustrating an example of a data collective compression processing sequence using the present embodiment in the storage system 102. In FIG. 14, components of the information system 101 are partially omitted in order to describe the data collective compression processing sequence. In addition, a size of write data from the host 103 is equivalent to that of the LDEV page 1303, and a collective compression unit is described as four LDEV pages 1303.

The host 103 sequentially writes pieces of data 1501 to 1507 to the CTL 104 (1508 to 1513). Pieces of write data are temporarily stored in the cache area 204, and the CTL 104 determines a group of pieces of write data to be collectively compressed in neighboring LBAs based on each LDEV # and each LBA of the pieces of data 1501 to 1507.

The neighboring LBAs (data of the same compression group) are determined based on a predetermined criterion. For example, in the same LDEV #, LBAs within 1% of an LBA space from a position (block number) of an LBA of interest are grouped as neighbors. In addition, cache segments of LBAs in a preset range, such as an address range and a ratio of a write destination of write data, may be determined as the same collective compression group.

In addition to the above method, a range according to a configuration and an operation form of the storage system 102 may be set regarding the neighboring LBAs. For example, an LBA space of the same LDEV # can be divided into a plurality of spaces, and LBAs in a divided space can be set as the neighboring LBAs to be collectively compressed.

The group (data group) to be collectively compressed is collectively compressed in a case where data equal to or more than the collective compression unit exists in the cache area 204. The collective compression is performed in the compression unit. In FIG. 15, the pieces of data 1503 and 1506 are not compressed at this point, and the pieces of data 1501, 1502, 1504, and 1506 are collectively compressed (1514).

Compressed data_updated 1515 is temporarily stored in the cache area 204 and then transferred to the PDEV 110 (1516).

In this manner, it is possible to reliably prevent the occurrence of secondary read-modify-write, collectively compress data having high similarity, and improve the data reduction rate by using the storage system 102 of the present embodiment.

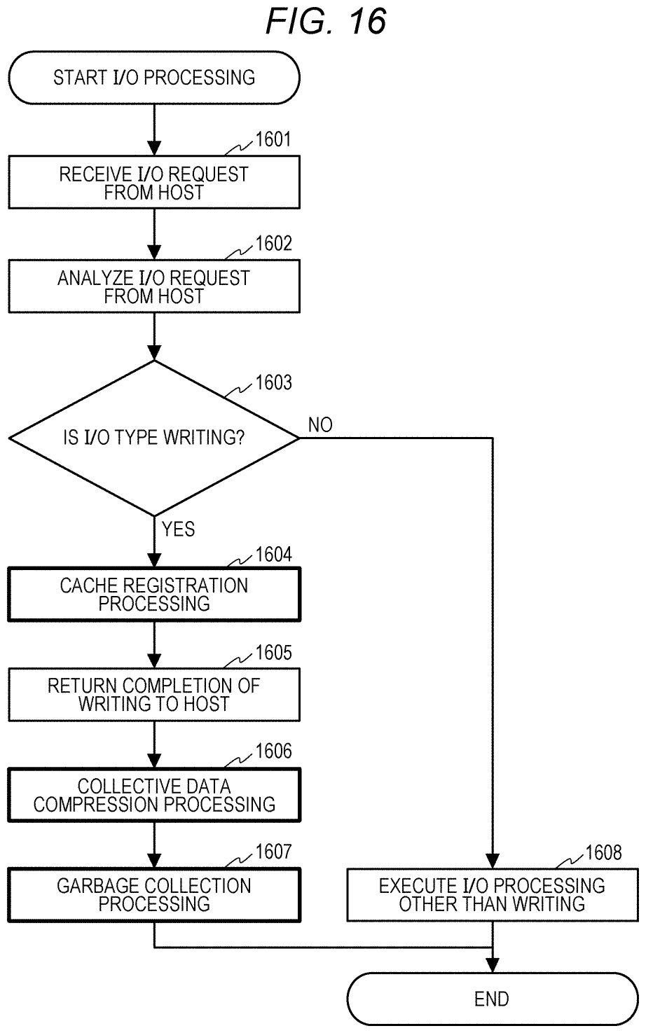

FIG. 16 is a flowchart illustrating an example of a flow in which the storage system 102 processes an I/O request received from the host 103.

The CTL 104 receives an I/O request from the host 103 (1601). The CTL 104 analyzes the received I/O request and acquires an I/O type (a read request, a write request, or the like) and the like (1602).

The CTL 104 determines whether the I/O type is the write request by using the I/O type acquired in the analysis processing (1602) for the I/O request from the host 103 (1603). In the processing 1603, not only the determination of the I/O type but also determination on whether an access pattern is random or sequential is performed. As the processing further branches, a range to which the present embodiment is applied may be limited to a case where the access pattern is random.

For example, in a case where access destination addresses are consecutive for a predetermined generation, the access pattern is determined to be sequential. In a case where the predetermined generation is one generation, the access pattern is determined to be sequential when an access destination address is consecutive with an immediately previous access destination address. When the access pattern does not satisfy the above condition, the sequential pattern is determined to be random. When the I/O type is the write request (1603: YES), the flow proceeds to processing 1604. On the other hand, when the I/O type is not the write request (1603: NO), the flow proceeds to processing 1608.

In the processing 1604, the CTL 104 calls cache registration processing and registers write data in the cache area 204 (1604). Incidentally, the cache registration processing will be described later. The CTL 104 notifies the host 103 of the completion of writing (1605).

The CTL 104 calls collective data compression processing to collectively compress the data in the cache area 204 (1606). Incidentally, the collective data compression processing will be described later.

The CTL 104 calls garbage collection processing in order to eliminate fragmentation in a PVOL page 1204 caused by log writing (postscript of data), executes the garbage collection processing, and then, ends the processing (1607). Incidentally, the garbage collection processing will be described later.

In the processing 1608 in which the I/O type is other than write, the CTL 104 executes processing based on the I/O request, and then ends, the processing (1608). Here, since the processing is not affected by the invention, the detailed processing will not be described. In addition, in FIG. 16, the collective data compression processing 1606 and the garbage collection processing 1607 are executed in synchronization with write from the host, but may be executed asynchronously, for example, may be executed periodically.

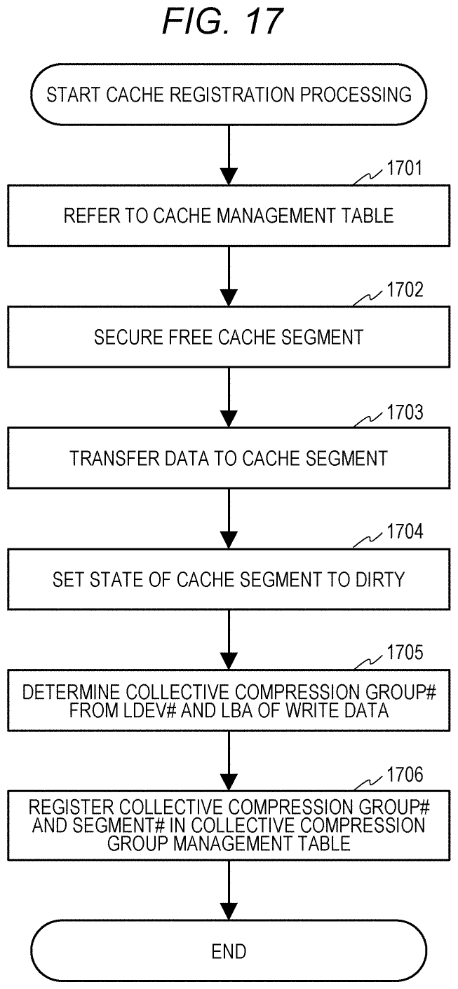

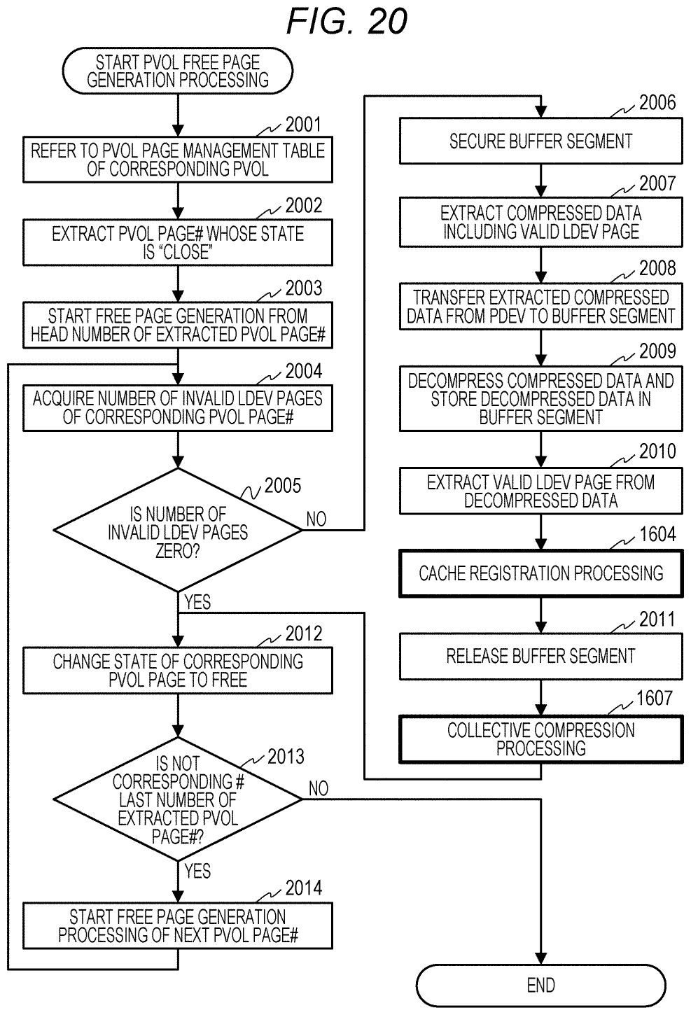

FIG. 17 is a flowchart illustrating an example of a flow of the cache registration processing (1604) called from the flowchart which has been described in FIG. 16 or will be described in FIG. 20 to be described later.

The CTL 104 refers to the cache segment management table 407 and acquires state information of a cache segment (1701). The CTL 104 secures the cache segment in which the state 1102 is “free” based on the information acquired in the processing 1701 (1702).

The CTL 104 transfers write data from the host 103 and data stored in a buffer segment in processing of a caller to the cache segment secured in the processing 1702 (1703). The CTL 104 updates the cache segment management table 407, and changes the state 1102 of the cache segment secured in the processing 1702 to “dirty” (1704).

The CTL 104 determines the collective compression group #1201 of neighboring LBAs based on an LDEV # and an LBA of the write data (1705). As described above, the collective compression group is obtained by grouping pieces of data in the same LDEV and neighboring LBAs, expected to store pieces of data having high similarity, into the same collective compression group #1201.

The CTL 104 registers a combination of the segment #1202 of the cache segment secured in the processing 1702 and the collective compression group #1201 determined in the processing 1605 to the collective compression group management table 408, and ends the processing (1706).

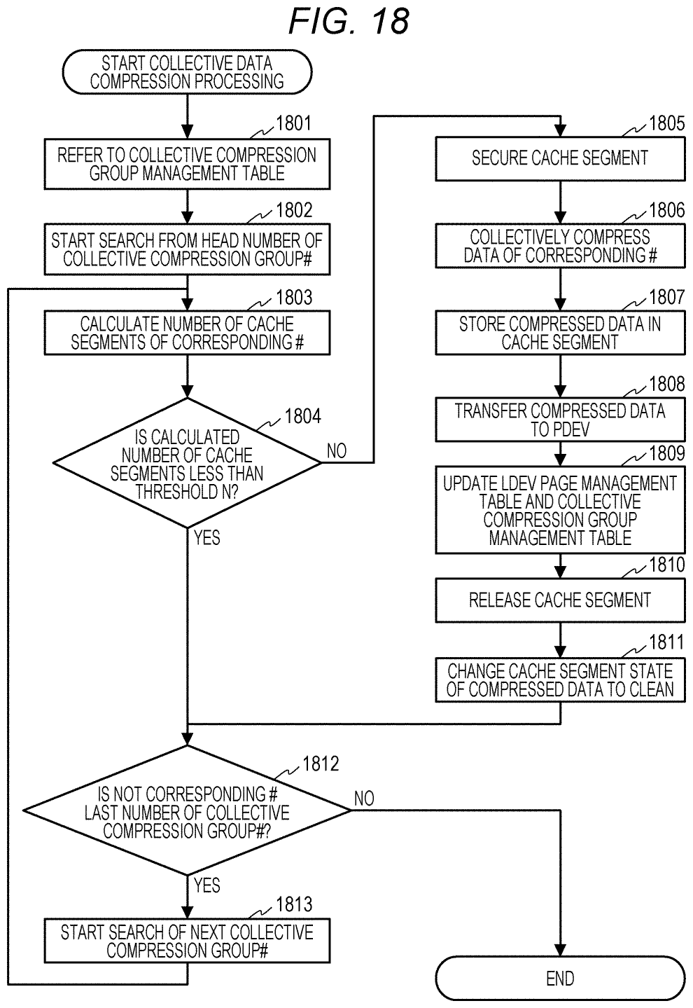

FIG. 18 is a flowchart illustrating an example of a flow of the collective data compression processing 1606 called from the flowchart described in FIG. 16.

The CTL 104 refers to the collective compression group management table 408 and acquires the collective compression group #1201 of the segment #1202 of a cache (1801). The CTL 104 starts a process of searching for a cache segment having a corresponding number in order from a head number of the collective compression group #1201 based on the information acquired in the processing 1801 (1802).

The CTL 104 calculates the number of cache segments having the collective compression group #1201 to be searched (1803). The CTL 104 determines whether the numerical value calculated in the processing 1803 is smaller than a threshold N. Incidentally, the threshold N may be a predetermined value equal to or larger than the number of LDEVs to be collectively compressed, may be a fixed value, or may be dynamically changed according to a usage status of a cache segment, an I/O load status, or the like.

When the calculated numerical value is smaller than the threshold N (1804: YES), the CTL 104 proceeds to processing 1712. On the other hand, when the calculated numerical value is not smaller than the threshold N (1804: NO), the CTL 104 proceeds to processing 1805.

In processing 1812, the CTL 104 determines whether the collective compression group # to be searched is the last number of the collective compression group #1201. When the collective compression group # to be searched is not the last number (1812: YES), the CTL 104 proceeds to processing 1813. On the other hand, when the collective compression group # to be searched is the last number (1812: NO), the processing is ended.

In the processing 1805 in which the number of cache segments is equal to or larger than the threshold N, the CTL 104 secures a cache segment (1805). The CTL 104 collectively compresses cache segments having the collective compression group #1201 to be searched (1806). Incidentally, the number (unit number) of pieces of write data to be collectively compressed may be a fixed value or may be dynamically changed according to a data compression rate, an I/O load status, or the like.

The CTL 104 stores the compressed data generated in the processing 1806 in the cache segment secured in the processing 1805 (1807). The CTL 104 transfers the compressed data generated in the processing 1806 to the PDEV 110 (1808). In the present embodiment, a storage system 0102 has a write-once data structure. Therefore, a storage destination PDEV 110 of the compressed data generated in the processing 1806 and a data position (address) to be stored are not fixed, and are determined each time according to a state of the storage system 0102.

For example, the CTL 104 may refer to the PVOL page management table 404 and use the PDEV 110 corresponding to the intra-PVOL page next write start address 805 and an address thereof in the PVOL page in which the state 802 is “open”. A state of a PVOL page in which the state 802 is “free” may be changed to “open”, and the corresponding PDEV 110 and an address thereof may be designated. At this time, the intra-PVOL page next write start address 805 in a data storage destination PVOL page is updated based on the generated compressed data size. Incidentally, the CTL 104 accesses the PDEV 110 via a PVOL by referring to the PVOL management table 402.

The CTL 104 updates the LDEV page management table 405, and changes the information (902 to 906) related to a data storage position for the LDEV page corresponding to the data stored in the PDEV 110 in the processing 1808. Further, the collective compression group management table 408 is updated, and an entry of the LDEV page corresponding to the data stored in the PDEV 110 in the processing 1808 is deleted (1809).

The CTL 104 releases the cache segment secured in the processing 1805 (1810). The CTL 104 updates the cache segment management table 407, and changes a state of the cache segment corresponding to the data stored in the PDEV in the processing 1808 to clean (1811). Incidentally, the state of the cache segment is changed to clean in FIG. 18, but may be changed to free. Thereafter, the flow proceeds to the processing 1812.

In the processing 1813 when the collective compression group # to be searched is not the last number, the CTL 104 advances the collective compression group # to be searched to the next number and returns to the processing 1803 and repeats the above processing in order to start the process of searching for the cache segment having the corresponding #.

Through the above processing, the CTL 104 collectively compresses N pieces of data for each collective compression group #1201 with neighboring LBAs. As a result, the improvement of the compression rate can be expected even in a case where LBAs of pieces of write data are not consecutive by collectively compressing a plurality of pieces of write data with neighboring LBAs in which it can be expected that pieces of data having similarity are stored.

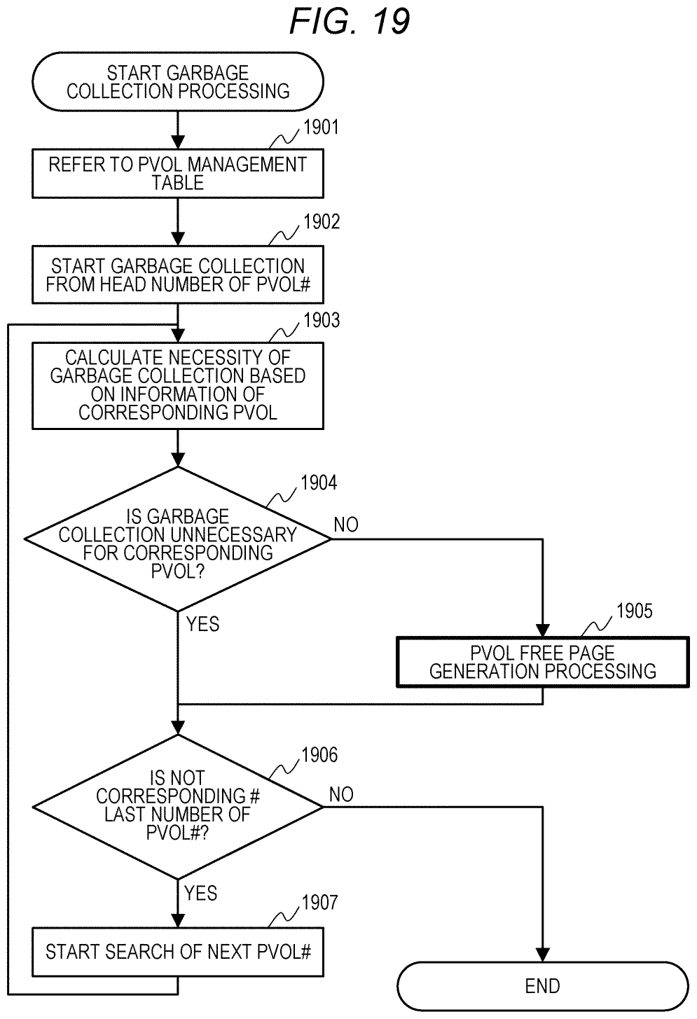

FIG. 19 is a flowchart illustrating an example of a flow of the garbage collection processing 1607 called from the flowchart described in FIG. 16.

The CTL 104 refers to the PVOL management table 402 and acquires information such as the used capacity/total capacity 602 and the garbage rate of used capacity 603 (1901). The CTL 104 starts the garbage collection processing on a PVOL of the corresponding # from a head number of the PVOL #601 based on the information acquired in the processing 1901 (1902).

The CTL 104 calculates whether the garbage collection is necessary for the PVOL of the corresponding #based on the information acquired in the processing 1901 (1903). In the calculation of whether the garbage collection is necessary, the CTL 104 determines that the garbage collection is necessary, for example, when the used capacity with respect to the total capacity exceeds a predefined threshold and the garbage rate (603) also exceeds a predefined threshold.

The CTL 104 determines whether the garbage collection is unnecessary for the PVOL of the corresponding # based on the result calculated in the processing 1903 (1904). When the garbage collection is unnecessary (1904: YES), the flow proceeds to processing 1906. On the other hand, when the garbage collection is necessary (1904: NO), the flow proceeds to processing 1905.

In the processing 1906, the CTL 104 determines whether the corresponding # is not the last number of the PVOL #. When the corresponding # is not the last number (1906: YES), the flow proceeds to processing 1907. On the other hand, when the corresponding # is the last number (1906: NO), the processing is ended.

In the processing 1905, the CTL 104 calls PVOL free page generation processing, and proceeds to the processing 1906 after the processing ends. Incidentally, the PVOL free page generation processing will be described later.

In the processing 1907, the CTL 104 advances a PVOL # of a garbage collection target to the next number, and returns to the processing 1803 and repeats the above processing in order to start the garbage collection processing of a PVOL having the corresponding # (1907).

Incidentally, the garbage collection processing may be executed when a predetermined condition is satisfied, such as when a load of the CTL 104 is low.

FIG. 20 is a flowchart illustrating an example of a flow of the PVOL free page generation processing (1905) called from the flowchart described in FIG. 19.

The CTL 104 refers to the PVOL page management table 404 corresponding to a PVOL # instructed by the caller to acquire information of the state 802 (2001). The CTL 104 extracts a PVOL page # in which the state 802 is “close” based on the information acquired in the processing 2001 (2002).

The CTL 104 starts the PVOL free page generation processing from a head number of the PVOL page # based on the information extracted in the processing 2002 (2003). The CTL 104 refers to the PVOL page management table 404 to acquire the number of invalid LDEV pages 804 of the PVOL page # (2004).

The CTL 104 determines whether the number of invalid LDEV pages 804 of the PVOL page # is zero based on the information acquired in the processing 2004 (2005). When the number of invalid LDEV pages 804 is zero (2005: YES), the flow proceeds to processing 2012. On the other hand, when the number of invalid LDEV pages 804 is not zero (2005: NO), the flow proceeds to processing 2006.

The CTL 104 updates the PVOL page management table 404 and changes the state 802 of the PVOL page # to free (2012).

In processing 2013, the CTL 104 determines whether the corresponding # is not the last number of the PVOL page # extracted in the processing 2002. When the corresponding # is not the last number (2013: YES), the flow proceeds to processing 2014. On the other hand, when the corresponding # is the last number (2013: NO), the processing is ended.

In the processing 2006, the CTL 104 secures a buffer segment. The CTL 104 refers to the PVOL page management table 404 of a PVOL corresponding to the corresponding # and extracts the PVOL page # in which the number of valid LDEV pages 803 is one or more.

Next, the CTL 104 refers to the PVOL management table 402, refers to the belonging LDEV 604 of the PVOL page #, and acquires all the LDEV page management tables 405 corresponding to the corresponding LDEV.

In addition, the CTL 104 refers to each of the acquired LDEV page management tables 405, and extracts compressed data including a valid LDEV page based on information of the allocation destination PVOL page #903, the intra-PVOL page start address 904, and the compressed size 905 (2007).

In FIG. 20, the LDEV page management table 405 is searched in order to extract the valid LDEV page belonging to the PVOL page #, but a table having LDEV pages belonging to each PVOL page may be created, and a valid LDEV page may be extracted by referring to this table.

The CTL 104 transfers the compressed data extracted in the processing 2007 from the PDEV 110 to the buffer segment secured in the processing 1906 (2008). The CTL 104 decompresses the compressed data and stores the decompressed data in the buffer segment secured in the processing 2006 (2009).

The CTL 104 extracts the valid LDEV page from the data decompressed in the processing 2009 (2010). The CTL 104 calls the cache registration processing in order to register the valid LDEV page extracted in the processing 2010 in a cache (1604).

The CTL 104 releases the buffer segment secured in the processing 2006 (2011). The CTL 104 calls collective compression processing (1607). Thereafter, the flow proceeds to the processing 2012.

In the processing 2014 in a case where the extracted PVOL page # is not the last page, the CTL 104 advances the target PVOL page # to the next number, and returns to the processing 2004 and repeats the above processing in order to start the free page generation processing of the PVOL page 1304 including the corresponding # (2014).

According to the above processing, it is possible to generate a free page in the PVOL 1202 by collectively compressing cache segments of neighboring LBAs even at the time of garbage collection and to improve the compression rate.

### Second Embodiment

Hereinafter, differences from the above-described first embodiment will be mainly described as the second embodiment. The second embodiment enables efficient garbage collection processing as compared with the first embodiment.

FIG. 21 is a view illustrating an example of a data collective compression processing sequence in the storage system 102. Components of the information system 101 are partially omitted in order to describe the data collective compression processing sequence. In addition, a size of write data from the host 103 is equivalent to that of the LDEV page 1303, and a collective compression unit is described as four LDEV pages 1303. Further, a plurality of pieces of compressed data belonging to the same collective compression group are consecutively stored in the PDEV 101 (PVOL) in the second embodiment. The plurality of pieces of compressed data to be consecutively written are collectively referred to as a “compressed data consecutive storage unit”. Incidentally, the number of pieces of compressed data constituting the compressed data consecutive storage unit is described as two.

The host 103 sequentially writes pieces of data 2101 to 2112 to the CTL 104 (2113 to 2124). Pieces of write data are temporarily stored in the cache area 204, and the CTL 104 determines a group of pieces of write data to be collectively compressed in neighboring LBAs based on each LDEV # and each LBA of the pieces of data 2101 to 2112.

A neighboring LBA is determined based on a predetermined criterion similar to that of the first embodiment. For example, LBAs within 1% of an LBA space from a position (block number) of an LBA of interest are grouped as neighboring LBAs in the same LDEV #. In addition, data may be determined such that cache segments of LBAs in a preset range, such as an address range and a ratio of a write destination of write data, belong to the same collective compression group.

Regarding the neighboring LBAs, in addition to the above method, a range according to a configuration and an operation form of the storage system 102 may be set according to a predetermined criterion. For example, an LBA space of the same LDEV # can be divided into a plurality of spaces, and LBAs in a divided space can be set as the neighboring LBAs to be collectively compressed.

In a case where pieces of data equal to or more than a number (4*2=8 in this example), obtained by multiplying the number of write data configurations of the collective compression unit by the number of compressed data configurations of the compressed data consecutive storage unit, exist in the cache area 204, groups (data group) to be collectively compressed are collectively compressed for each compression unit. In FIG. 21, the pieces of data 2103, 2105, 2107, and 2111 are not compressed at this point, and data groups 2101, 2102, 2104, 2106, 2108, 2109, 2120, and 2112 are collectively compressed every four groups (2125, 2126).

Compressed data_updated (2127, 2128) is temporarily stored in the cache area 204 and then transferred to the PDEV 110 (2129).

In this manner, pieces of compressed data belonging to the same collective compression group are consecutively (in the order of consecutive addresses) stored in the PDEV 110 for at least the number of configurations of the compressed data consecutive storage unit in the second embodiment. As a result, it is possible to efficiently extract valid LDEV pages belonging to the same collective compression group during garbage collection.

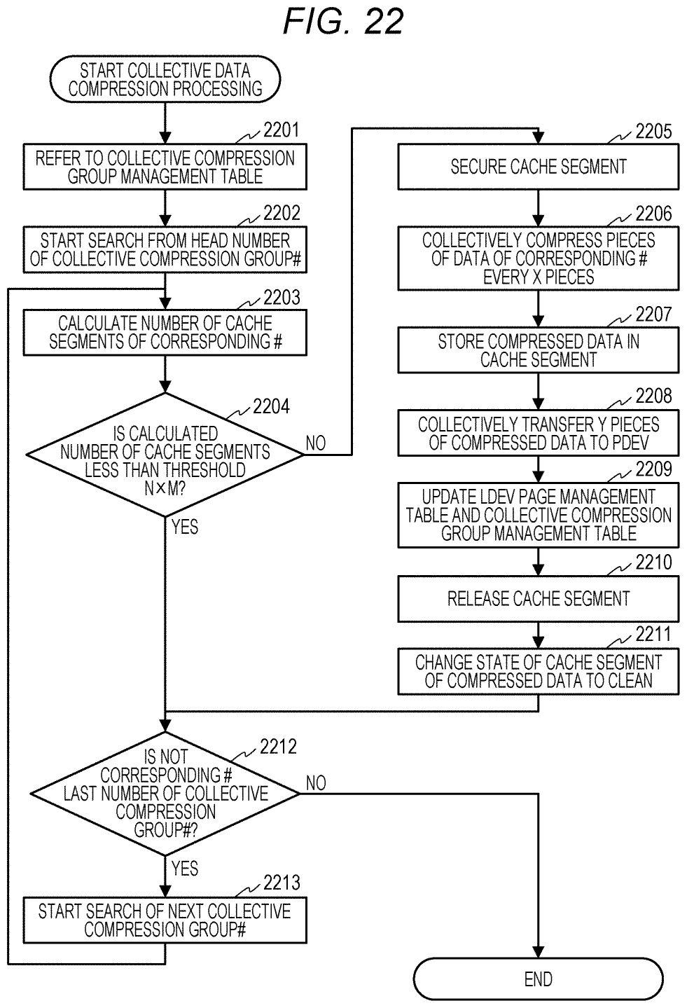

FIG. 22 is a flowchart illustrating an example of a flow of the collective data compression processing 1606 called from the flowchart described in FIG. 16 in the second embodiment. A description regarding similar processing as that of the first embodiment will be omitted hereinafter.

Processing 2201 to processing 2203 are the same as the processing 1801 to the processing 1803 of FIG. 18.

The CTL 104 determines whether a numerical value calculated in the processing 2203 is smaller than a threshold N×M. Incidentally, the threshold N is a predetermined value equal to or larger than the number of LDEVs to be collectively compressed, and the threshold M is a predetermined value equal to or larger than the number of compressed data configurations of the compressed data consecutive storage unit. The thresholds N and M may be fixed values, or may be dynamically changed according to a usage status of a cache segment, an I/O load status, or the like.

When the calculated numerical value is smaller than the threshold N×M (2204: YES), the CTL 104 proceeds to processing 2212. On the other hand, when the calculated numerical value is not smaller than the threshold N (2204: NO), the CTL 104 proceeds to processing 2205. Incidentally, the processing 2212 is the same as the processing 1812 in FIG. 18.

In the processing 2205 in which the number of cache segments is equal to or larger than the threshold N×M, the CTL 104 secures a cache segment (2205). The CTL 104 collectively compresses cache segments having the collective compression group #1201 to be searched every X cache segments to create Y pieces of compressed data (2206). Incidentally, the number of write data configurations X of the collective compression unit and the number of compression data configurations Y of the compressed data consecutive storage unit may be fixed values, or may be dynamically changed according to a data compression rate, an I/O load status, or the like.

The CTL 104 stores the compressed data, generated in the processing 2006, in the cache segment secured in the processing 2005 (2007). The CTL 104 collectively transfers the Y pieces of compressed data generated in the processing 2006 so as to be consecutively stored in the PDEV 110 (2008). The storage destination PDEV 110 of the compressed data generated in the processing 2006 and a data position (address) to be stored are determined by the same method as in the processing 1808 described above. However, the storage destination is determined such that the Y pieces of compressed data generated in the processing 2006 are stored in consecutive-address areas on the PVOL.

Processing 2209 to processing 2211 are similar to the processing 1809 to the processing 1811 of FIG. 18. In addition, processing 2213 is similar to the processing 1813 of FIG. 18.

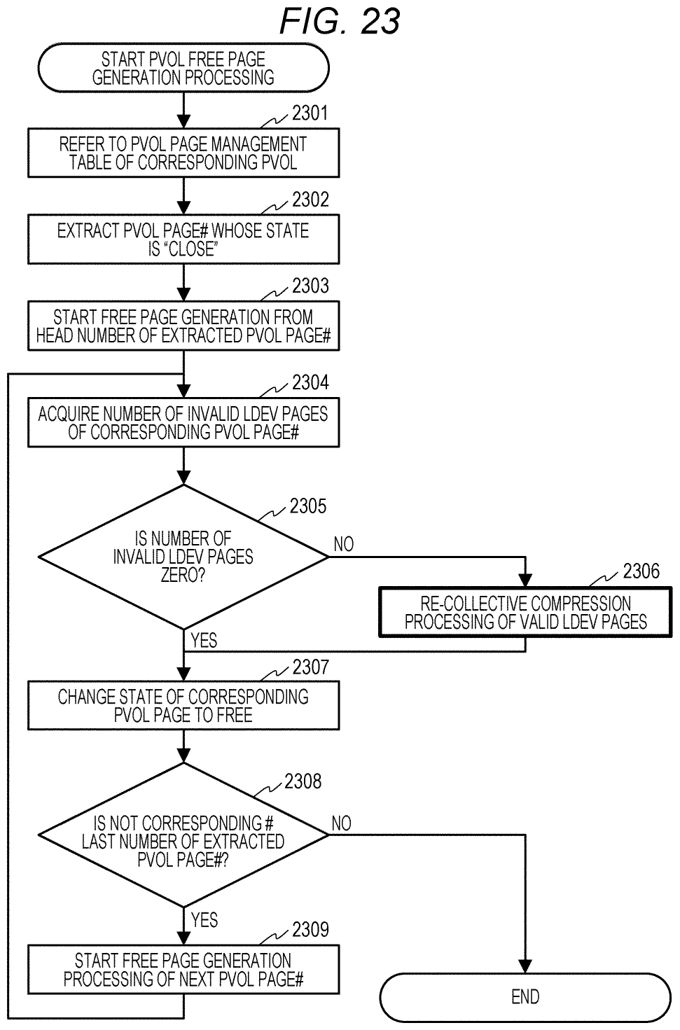

FIG. 23 is a flowchart illustrating an example of a flow of the PVOL free page generation processing (1905) called from the flowchart described in FIG. 19.

Processing 2301 to processing 2304 are similar to the processing 2001 to the processing 2004 of FIG. 20. In addition, processing 2307 is similar to the processing 2012 in FIG. 20, processing 2308 is similar to the processing 2013 in FIG. 20, and processing 2309 is similar to the processing 2014 in FIG. 20.

The CTL 104 determines whether the number of invalid LDEV pages 804 of the PVOL page # is zero based on the information acquired in the processing 2304 (2305). When the number of invalid LDEV pages 804 is zero (2305: YES), the flow proceeds to processing 2306. On the other hand, when the number of invalid LDEV pages 804 is not zero (2305: NO), the flow proceeds to processing 2307.

The CTL 104 calls re-collective compression processing of valid LDEV pages (2306). Details of this processing will be described later.

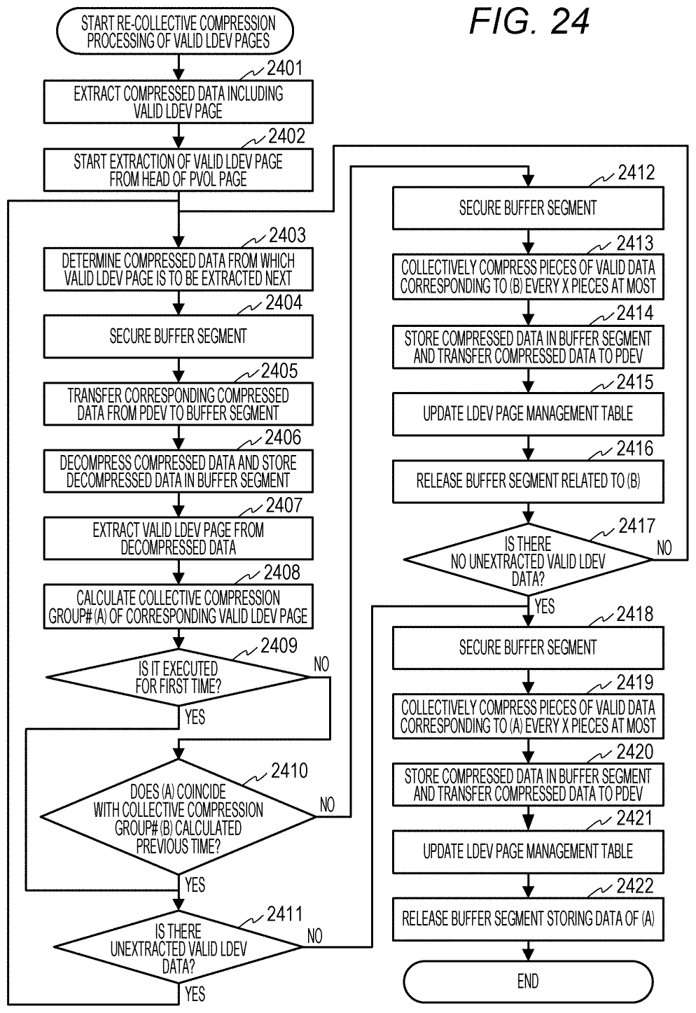

FIG. 24 is a flowchart illustrating an example of a flow of the re-collective compression processing of valid LDEV pages (2306) called from the flowchart described in FIG. 23.

The CTL 104 refers to the PVOL page management table 404 of a PVOL corresponding to the corresponding # and extracts the PVOL page # in which the number of valid LDEV pages 803 is one or more.

Next, the CTL 104 refers to the PVOL management table 402, refers to the belonging LDEV 604 of the PVOL page #, and acquires all the LDEV page management tables 405 corresponding to the corresponding LDEV.

In addition, the CTL 104 refers to each of the acquired LDEV page management tables 405, and extracts compressed data including a valid LDEV page based on information of the allocation destination PVOL page #903, the intra-PVOL page start address 904, and the compressed size 905 (2401).

In FIG. 24, the LDEV page management table 405 is searched in order to extract the valid LDEV page belonging to the PVOL page #, but a table having LDEV pages belonging to each PVOL page may be created, and a valid LDEV page may be extracted by referring to this table.

The CTL 104 starts a process of extracting valid data sequentially from a head address of the corresponding PVOL page for the compressed data extracted in the processing 2401 (processing 2402).

The CTL 104 selects first compressed data at the time of executing the above extraction for the first time, and determines compressed data including a valid LDEV page next to the previously selected compressed data as the compressed data from which valid data is to extracted next at the time of executing the above extraction for the second and subsequent times (2403).

In processing 2404, the CTL 104 secures a buffer segment. The compressed data selected in the processing 2403 is transferred from the PDEV 110 to the buffer segment secured in the processing 2404 (2405). The CTL 104 decompresses the compressed data and stores the decompressed data in the buffer segment secured in the processing 2403 (2406).

The CTL 104 extracts the valid LDEV page from the data decompressed in the processing 2406 (2407). The CTL 104 determines a collective compression group to be collectively compressed with neighboring LBAs based on an LDEV # and a LBA of the extracted valid LDEV page, and sets this group # as (A) (2408).

In processing 2409, when the CTL 104 executes the processing 2403 to the processing 2408 for the first time (2409: YES), the flow proceeds to processing 2411. On the other hand, in the case of the second and subsequent times (2409: NO), the flow proceeds to the processing 2401.

In processing 2410, the CTL 104 compares a compression group # (B), calculated in the processing 2408 when the processing 2403 to the processing 2408 have been previously executed, with (A) calculated this time. When (A) and (B) coincide as a result of the comparison (2410: YES), the flow proceeds to the processing 2411. On the other hand, when (A) and (B) do not coincide (2410: NO), the flow proceeds to processing 2412.

In the processing 2411, the CTL 104 compares pieces of compressed data that have been extracted so far with the compressed data extracted in the processing 2401, and confirms the presence or absence of compressed data that has not yet been extracted to determine whether unextracted valid LDEV data exists in the PVOL page. When there is valid LDEV data that has not yet been extracted (2411: YES), the flow returns to the processing 2403 and repeats the above processing. On the other hand, when there is no valid LDEV data that has not yet been extracted (2411: NO), the flow proceeds to processing 2418.

In the processing 2412, the CTL 104 secures a buffer segment. In processing 2413, the CTL 104 performs collective compression on the valid LDEV data of which the collective compression group # is (B) extracted in the processing 2403 to the processing 2408. At this time, in the second embodiment, the pieces of compressed data of the same collective compression group # are consecutively stored in the PVOL page in the order of addresses as described with reference to FIG. 21. Thus, the pieces of valid LDEV data of the same collective compression group # can be efficiently collected by extracting the valid LDEV pages in order of addresses from the head of the PVOL page.

Next, the CTL 104 executes collective compression processing for each number X of pieces of write data to be collectively compressed in the processing 2413. At this time, when target valid LDEV data is not a multiple of X, the collective compression is performed on a valid LDEV page, which is a fraction less than X, with a fraction less than X. This is because extraction of the valid LDEV page belonging to the same collective compression group # as (B) causes deterioration in processing efficiency of garbage collection.

Incidentally, compressed data smaller than the collective compression unit is generated in the above-described method, and thus, there is a possibility that a compression rate decreases as compared with a case where collective compression is always performed with the collective compression unit X. When the decrease in the compression rate is not allowable, the cache registration processing 1604 and the collective data compression processing 1606 may be executed for the valid LDEV page of the fraction less than X as in the first embodiment such that the collective compression can be necessarily performed in the collective compression unit X.

The CTL 104 temporarily stores the compressed data generated in the processing 2413 in the buffer segment of the buffer area 203 and transfers the compressed data to the PDEV 110 (2414). The storage destination PDEV 110 of the compressed data generated in the processing 2413 and a data position (address) to be stored are determined by the same method as in the processing 1808 described above.

The CTL 104 updates the LDEV page management table 405, and changes the information (902 to 906) related to a data storage position for the LDEV page corresponding to the data stored in the PDEV 110 in the processing 2214 (2415).

The CTL 104 releases the buffer segment storing unnecessary data of the same collective compression group (B) (2416).

In processing 2417, the CTL 104 performs processing similar to the processing 1411, and determines whether there is unextracted valid LDEV data in the PVOL page.

When there is valid LDEV data that has not yet been extracted (2417: YES), the flow proceeds to processing 2418. On the other hand, when there is no valid LDEV data that has not yet been extracted (2418: NO), the flow returns to the processing 2403 and repeats the above processing.

Processing 2418 to processing 2422 are similar to the processing 2412 to the processing 2416 except that a collective compression group # to be subjected to collective compression is (A), and thus, the description thereof will be omitted. Incidentally, the CTL 104 ends the processing after executing the processing 2422.

Through the above processing, the valid LDEV page, necessary for the garbage collection of the first embodiment, is registered again in the cache in the second embodiment, so that it is possible to make it unnecessary to execute the garbage collection processing again from the provision of the collective compression group #, and it is possible to improve the efficiency of the garbage collection processing.

As described above, the storage system 102 according to the present embodiment collectively compresses the cache segments of the neighboring LBAs in the write data to collectively compress the plurality of pieces of data expected to have similarity. Thus, the improvement of the compression rate can be expected even in the case where LBAs of the write data are not consecutive, and the bit cost of the AFA can be reduced. In addition, in a case where write data having a size less than the compression unit is received from a user, it is possible to prevent the occurrence of RMW accompanying an increase in the compression unit and to suppress deterioration in I/O performance of the AFA and deterioration in the life of the SSD.

Incidentally, the example in which the LBA is used as the block storage has been described in the above embodiments, but the invention is not limited thereto, and a chunk or the like may be used for management. In the case of sequential write in which host write is written in the order of LBAs, RMW does not occur even if the conventional method is used regardless of the host write unit. Since RMW occurs when host write is written not in the LBA order but randomly, the features of the present disclosure are effective in the case of random write.

Incidentally, the invention is not limited to the above-described embodiments, but includes various modifications. For example, the above-described embodiments have been described in detail in order to describe the invention in an easily understandable manner, and are not necessarily limited to those including the entire configuration that has been described above. Further, some configurations of a certain embodiment can be substituted by configurations of another embodiment, and further, a configuration of another embodiment can be also added to a configuration of a certain embodiment. Further, addition, deletion, or replacement of other configurations can be applied alone or in combination for a part of the configuration of each embodiment.

Further, a part or all of each of the above-described configurations, functions, processing units, processing means, and the like may be realized, for example, by hardware by designing with an integrated circuit and the like. Further, each of the above-described configurations, functions, and the like may also be realized by software by causing a processor to interpret and execute a program for realizing each of the functions. Information such as programs, tables, and files that realize the respective functions can be installed in a storage device such as a memory, a hard disk, and a solid state drive (SSD), or a storage medium such as an IC card, an SD card, and a DVD.

In addition, only a control line and an information line considered to be necessary for the description have been illustrated, and all control lines and information lines required for a product are not illustrated. It may be considered that most of the configurations are practically connected to each other.

What is claimed is:

1. A storage system comprising:
a controller which includes a processor and a memory; and
one or more storage devices,
wherein the controller
sets a plurality of logical volumes,
stores data related to a write request in the memory when the write request is received in the logical volumes, and
collectively compresses a plurality of pieces of the data related to the write request in the memory and writes the compressed data to the storage device,
when a plurality of pieces of data related to a plurality of the logical volumes that need to be written to the storage device exist in the memory, the controller selects the plurality of pieces of data whose writing positions in an identical logical volume are inconsecutive, and collectively compresses the plurality of pieces of selected data and writes the compressed data in the storage device.

2. The storage system according to claim 1, wherein
when storage positions of the plurality of pieces of data, related to the identical logical volume, in the logical volume are not consecutive, the controller selects pieces of data whose storage positions are determined to be close based on a predetermined criterion and collectively compresses the selected pieces of data.

3. The storage system according to claim 2, wherein
the controller divides the storage positions into predetermined ranges, and determines that the storage positions are close when the storage positions are in an identical range.

4. The storage system according to claim 1, wherein
the write request is a write request for updating data, and
the controller stores updated data at a position on the storage device different from a position of data before updating.

5. The storage system according to claim 1, wherein
the controller decompresses data, compressed and stored in the storage device, and stores the decompressed data in the memory during garbage collection in which a storage position of the data is rearranged, and
the plurality of pieces of data to be collectively compressed include data related to the garbage collection.

6. The storage system according to claim 5, wherein
the plurality of pieces of data to be collectively compressed includes data related to the write request.

7. The storage system according to claim 6, wherein
the data related to the garbage collection and the data related to the write request are collectively compressible.

8. The storage system according to claim 2, wherein the controller
manages allocation of a storage area via a second volume between the storage device and the logical volume,
causes pieces of data whose storage positions are determined to be close based on the predetermined criterion to be included in an identical group,
collectively compresses a plurality of pieces of data selected from the identical group to generate the compressed data, and
writes a plurality of pieces of the compressed data generated from the identical group to the second volume in order of consecutive addresses.

9. The storage system according to claim 8, wherein the controller
decompresses data compressed and stored in the storage device and stores the decompressed data in the memory during garbage collection in which a storage position of the data is rearranged, and
extracts pieces of valid data from the decompressed data in the memory in order of addresses of the second volume, and
collectively compress pieces of valid data in the identical group among the pieces of extracted valid data.

10. A control method for a storage system, which includes a controller including a processor and a memory, and one or more storage devices, the control method, executed by the controller, comprising:
setting a plurality of logical volumes;
storing data related to a write request in the memory when the write request is received in the logical volume;
collectively compressing a plurality of pieces of the data related to the write request in the memory and writing the compressed data to the storage device; and
selecting a plurality of pieces of data whose writing positions in an identical logical volume are inconsecutive when the plurality of pieces of data related to a plurality of the logical volumes that need to be written to the storage device exist in the memory, and collectively compressing the plurality of pieces of selected data and writing the compressed data in the storage device.
